(19) United States
(12) Patent Application Publication
(10) Pub. No.: US 2014/0110930 A1
(43) Pub. Date: Apr. 24, 2014

(54) INFORMATION MEDIUM WITH PRINTED IDENTIFICAITON INFORMATION AND ANTI-FORGERY MEANS

(71) Applicants: Jean-Luc Lesur, Meudon (FR); Pascal Guterman, Meudon (FR)

(72) Inventors: Jean-Luc Lesur, Meudon (FR); Pascal Guterman, Meudon (FR)

(73) Assignee: GEMALTO SA, Meudon (FR)

(21) Appl. No.: 13/122,683

(22) PCT Filed: May 22, 2008
(86) PCT No.: PCT/IB08/01282

§ 371 Date: Apr. 5, 2011

(30) Foreign Application Priority Data
May 24, 2007 (EP) 07290665.4

(51) Int. Cl. B42D 15/00

(52) U.S. Cl. CPC B42D 15/0013
USPC 283/85

(57) ABSTRACT

The invention relates to the securing of information media so as to prevent any alteration or modification of the identification information and the fraudulent reuse of the media. The identification document according to the invention comprises personalisation information placed on at least one of its main sides, and invisible anti-forgery means placed on at least part of the said side and designed to undergo a change in appearance in the event of an attempt to do additional personalisation. The anti-forgery means are formed by subdividing each pixel into a matrix of N dots, the said N dots having each a different colour density in order to obtain an average colour density of the said matrix that is equivalent to the colour density predetermined for the corresponding pixel, at least some of the said N dots of the matrix being pre-sensitised so that their colour darkens at a variable speed in the event of additional personalisation, as compared to the other non pre-sensitised dots

This invention relates to the security of information or data medium. More particularly, the invention relates to the security of information media so that the identification information printed on their surface in particular is not altered or modified and so that the media cannot thus be reused fraudulently.

The invention relates to the field of identification documents with or without microchips, such as driving licences, identity cards, membership cards, access control cards, passports, bankcards, electronic purses, multi-application cards and other security documents. Because of the value and importance of all these documents, they are often copied without permission, altered, modified and forged.

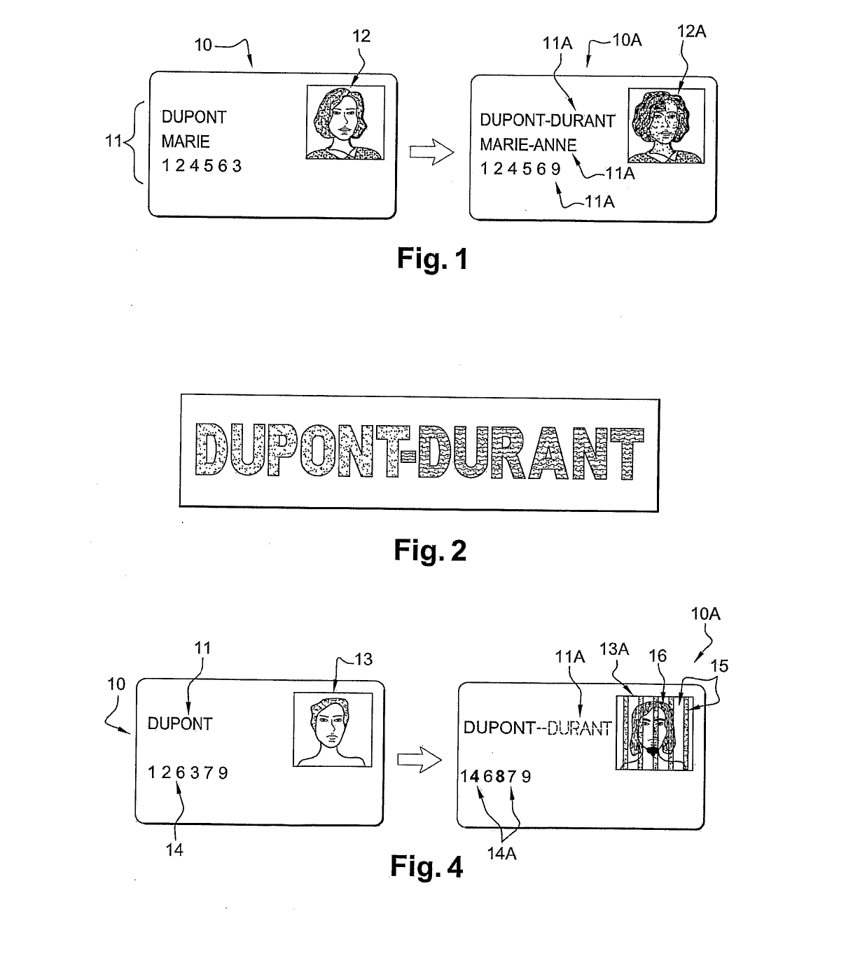

For instance, laser printing does not make it possible to prevent the addition of information. Such added information may for instance completely change a photograph by adding more hair and/or a moustache and/or glasses etc. An example of a forgery of photographs by adding areas darkened with a laser beam has been illustrated in FIG. 1. On the original card 10, information about the identity of the holder is provided in a text box 11, and a photograph 12 of the holder is printed, for example with a laser beam, by burning the surface of the card body. The resulting localised surface discoloration depends on the energy available, the writing time and the material used for the card body. This photograph is printed by burning the surface of the card body with a laser, and is thus indelible and the blackened areas cannot be removed. On the other hand, blackened areas can be added, for instance in the text box 11 to modify the identity of the holder by adding alphanumeric characters, and also on the photograph 12 to modify the features of the holder. In the example in FIG. 1, the original photograph 12 of the card 10 is modified, hair has been added with a laser beam and dark areas have been added to raise, the cheekbones and change the colour of the skin, so that a new forged photograph 12A is now on the card 10A. Similarly, the identity of the card holder is forged by modifying and adding alphanumeric characters 11A.

To prevent such forgery with identification documents, different sorts of security means are used. One solution consists in superimposing curved light lines, also called guilloches, on an identification picture such as a photograph. If any material is printed subsequently, the guilloches blacken and appear darker than the addition.

Patent application FR2890332 describes a solution that consists in depositing invisible anti-forgery means around the personalised graphics, i.e. in the non-printed areas of the surface of the medium, immediately next to the printed areas, i.e. alphanumeric areas or picture areas. These anti-forgery means may for instance include a pattern of lines that are revealed when additional personalised graphics are added. In that way, if a forger wants to add hair around the photograph, the darker lines will show in the added hair. Similarly, if the identity of the holder is modified, say by adding a second surname as shown in FIG. 2, the surname “DURANT” inserted additionally brings out lines that were concealed until then. In that way, an attempt to modify and alter the information of the holder of the medium can immediately be detected by the naked eye.

However, that solution remains limited, in that it only makes it possible to detect changes in the so-called blank areas on the surface of the medium, located around the printed areas, but does not prevent the making of changes in the various printed areas, as on the face in a photograph, for instance. As a result, even if the solution does make it impossible to add hair to a photograph, it does not prevent the adding of glasses or a moustache, or the alteration of features, such as making the cheekbones more prominent or the complexion darker, for instance.

Other solutions consist in adding security elements such as holograms, information printed with ink that reacts to ultraviolet radiation, micro-letters concealed in an image or text etc.

These solutions make it possible to secure information media adequately, but they require additional equipment and/or material leading to higher production costs.

That is why the technical problem object of the present invention consists in offering a secure information medium comprising personalisation information placed on at least one of its main surfaces, the said medium also comprising invisible anti-forgery means placed on at least part of the said surface to undergo a change of appearance if any attempt to add further personalisation is made, which would make any attempted forgery by adding information immediately visible to the naked eye, regardless of the area of the medium, printed or otherwise, in which such additional personalisation is carried out.

The solution to the technical problem posed is obtained according to this invention by the fact that the anti-forgery means are formed by a subdivision of each pixel into a matrix of N dots, the said N dots having a colour density different to each other so as to enable the achievement of an average colour density of the said matrix that is equivalent to the predetermined colour density for the corresponding pixel, at least some of the said N dots in the matrix being pre-sensitised to make their colour darken at a variable speed in the event of additional personalisation, as compared to the other non-sensitised dots.

In that way, a printable pixel, visible to the naked eye, is subdivided into a matrix of micro-pixels, also called dots throughout the remainder of the description, which are invisible to the naked eye and which each have a colour density that is such that the average colour of the matrix is the density predetermined for the corresponding pixel. Some of the dots are pre-sensitised to react differently if any addition is made to the personalisation. For instance, if a forger tries to modify a photograph by adding to it, the pre-sensitised dots of each matrix that undergo the addition offer a varying degree of reaction and go darker at varying speeds. As a result, depending on the number of pre-sensitised dots per matrix and the degree of pre-sensitisation of the dots, each matrix or corresponding pixel will react differently and some pixels will appear darker or lighter than the surrounding pixels. In that way, lines and/or text and/or logos will appear in tones that are darker and/or lighter than the average colour density, in the areas where additions have been made to the personalised information.

The invention also concerns a securing method for an information medium comprising personalisation information placed on at least one of its main surfaces, which said medium also comprising invisible anti-forgery means placed on at least part of the said surface and designed to undergo a change in appearance in the event of an attempt to add personalised information. The method is remarkable in that the making of the anti-forgery means comprises the following steps:
subdividing each pixel into a matrix of N dots,
pre-sensitising at least some of the said N dots at a predetermined colour density, so that the average density of the matrix is equivalent to a density predetermined for the corresponding pixel,
the said pre-sensitised dots are designed to darken more or less quicker than dots that are not pre-sensitised in the event of additional personalisation so as to modify the visual appearance of the pixel corresponding with the matrix.

Other particularities and benefits of the invention will appear in the following description, provided as an illustrative and non-limitative example, by reference to the enclosed figures representing:

FIG. 1, already described, is an identification card with an original text box and photograph and a forged card with a modified text box and photograph,

FIG. 2, already described, is the detail of the surface of a personalised information medium according to one known mode of embodiment and the effects produced in the event of an attempted forgery,

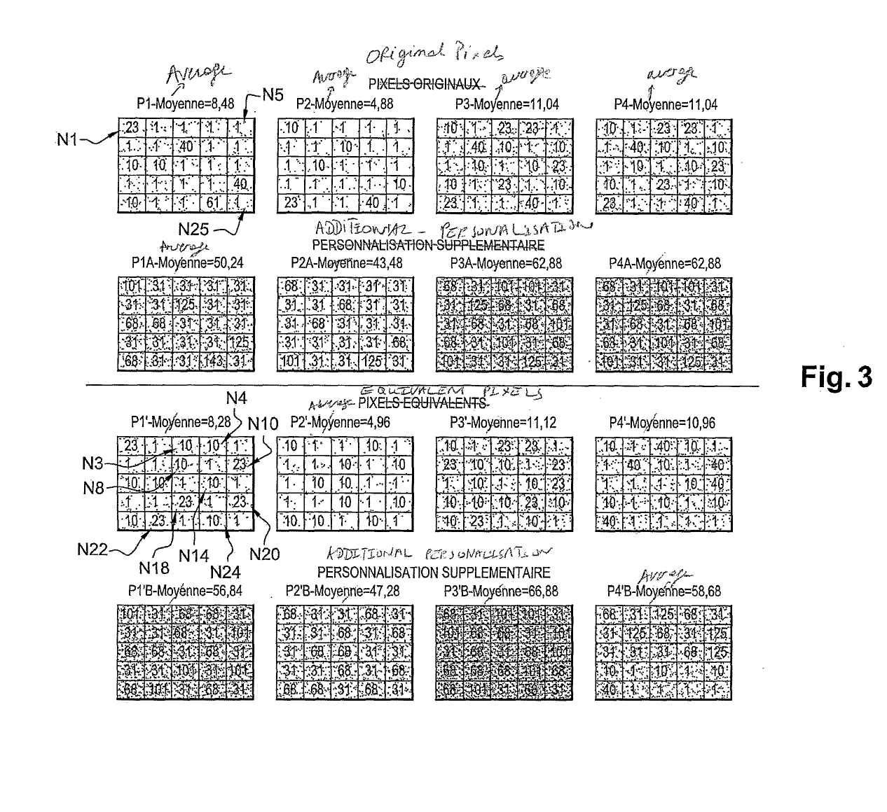

FIG. 3 is a diagram with four so-called original pixels and four so-called equivalent pixels subdivided into matrices of pre-sensitised dots in accordance with the invention,

FIG. 4 is a diagram of the effects produced in the event of an attempt to forge a secure medium of information according to the invention.

The examples described below relate to more or less rigid identification cards, such as identity cards. However, the invention is not limited to such cards, and extends to all sorts of identification objects, whether or not they contain electronic components, such as passports or other flexible security papers for instance.

An information medium generally comprises at least two main surfaces, front and back. Personalisation information is placed on at least one of these main surfaces. It also includes invisible anti-forgery means placed on at least part of the printed side. These anti-forgery means are provided to undergo a change in appearance if an attempt at forgery is made.

The anti-forgery means may thus be placed only on the printed areas of one side or on the entire surface of at least the side with the personalisation information. They are achieved by subdividing each printable pixel that is visible to the naked eye into a matrix of N micro-pixels that are invisible to the naked eye.

To make the description easier to understand, the term “darkening” will be used throughout the rest of the description to designate both darkening and lightening. Such darkening is achieved depending on the degree of pre-sensitisation of the dots that make up a pixel, i.e. according to their reactivity to laser beams.

The term pre-sensitisation is used throughout the rest of the description to designate the dots that make up pixels whose visual appearance is not modified but which can take on another appearance if forgery is attempted. Thus, for instance, white pixels pre-sensitised to different levels will have different appearances in the event of a forgery. Grey pixels may be called “pre-sensitised” pixels and also “more reactive” pixels, which will go darker or lighter in relation to the average in the event of a forgery.

The subdivision of pixels into matrices of dots is shown schematically in FIG. 3. In the example, four pixels P1, P2, P3, P4 are each subdivided into a matrix of N dots or micro-pixels. In the example, each matrix is made up of N=25 dots, but that number may vary.

Each dot Nn of a matrix has a predetermined colour density so that the average density of the matrix is the density selected for the corresponding pixel P1. With laser printing, there are 256 shades of grey, and each dot thus has a specific shade of grey. In the diagram in FIG. 3, each dot Nn is an integer representing a density of grey. For instance, for the matrix corresponding with pixel P1, the average density of the 25 dots N1 to N25 is equal to 8.48. Similarly, for the matrix corresponding with pixel P2, the average density of the 25 dots is equal to 4.88, for the matrix corresponding with pixel P3, the average density of the 25 dots is equal to 11.04 and lastly, for the matrix corresponding with pixel P4, the average density of the 25 dots is equal to 11.04. These four matrices each thus have a predetermined average grey density that can be seen by the naked eye, whilst each dot making up the matrix and contributing to the average grey density value remains invisible to the naked eye.

The four matrices, or corresponding pixels, referenced P1A, P2A, P3A and P4A, represent the same pixels P1, P2, P3 and P4 after undergoing additional personalisation with a laser. Because the grey shades are each variably sensitive to the laser beam, they do not all react identically and some grey shades go darker faster than others when they are subjected to the same laser radiation. That is how each dot of the matrix P1A, and of P2A, P3A and P4A, darkens variably after it is subjected to the laser beam. At the end of the additional personalisation, the matrix P1A has for example an average density of 50.24, matrix P2A has an average density of 43.48 and matrices P3A and P4A have an average density of 62.88. As a result, the grey density of the first matrix P1A has darkened on average by 41.76, that of the second matrix has darkened on average by 38.6 and those of the third and fourth matrices have darkened on average by 51.84.

In order to detect personalisation that has been added by a forger, at least some of the original pixels P1, P2, P3, P4 of the surface to be secured are replaced by so-called equivalent pixels P1′, P2′, P3′, P4′. For that, at least some of the dots of the equivalent matrix, corresponding with the equivalent pixel, are pre-sensitised so that the average grey density is equivalent to the original matrix corresponding with the original pixel. In this case, the pre-sensitised dots will react differently to the second personalisation, so that the equivalent matrix after the forged additional personalisation P1′B, P2′B, P3′B and P4′B, will not be equivalent to the original matrix after additional personalisation P1A, P2A, P3A, P4A.

For instance, in the equivalent matrix P1′, the dots N3, N4, N8, N10, N14, N18, N20, N22 and N24 are pre-sensitised differently from their counterparts in the original matrix P1. The average grey density of matrix P1′ is equal to 8.28, which value is very close and may be considered to be equivalent to value 8.48 of the average grey density of the original matrix P1. However, at the end of the forged personalisation, the pre-sensitised dots do not react in the same, way as those of matrix P1′. In that way, matrix P1′B has an average grey density equal to 56.84, which is darker than the average density of 50.24 of matrix P1′. At the end of the second personalisation, the average density of the equivalent matrix P1′ has thus risen by a value equal to 48.56. As a result, the pixel P1B′, equivalent corresponding with the matrix, appears darker than the original pixel P1A to the naked eye.

In the same way, in the example in FIG. 3, the equivalent matrices P2′B and P3′B appear darker than the original matrices P2A and P3A after the second personalisation.

The original matrix P4 is identical to matrix P3. On the other hand, at an equivalent average density value, the equivalent matrix P4′, whose equivalent average density is equal to 10.96, differs from the equivalent matrix P3′, whose average density is equal to 11.12. That is because the equivalent matrix P4′ does not at all have the same number of pre-sensitised dots or the same level of pre-sensitising as matrix P3′. For example, P4′ has fewer dots with a grey shade that is more reactive to laser beams than P3′. As a result, after forged additional personalisation, the corresponding pixel P4′B darkens much less than pixel P3′B. The average grey density of pixel P4′B is equal to 58.68 whereas the average density of pixel P3′B is 66.88. In this case, after forged personalisation, the pixel P4′B will appear lighter than an original non-sensitised pixel P4A, or another pixel P3′B that has been pre-sensitised differently.

This example is a good illustration of how, depending on the number of pre-sensitised dots and their degree of pre-sensitisation, i.e. on how reactive their grey shade is to a laser beam, the pixel corresponding with the matrix will appear darker or lighter to the eye. In that way, when the equivalent matrix P1′, P2′, P3′ includes more dots that are more reactive to the laser beam, the pixel P1′B, P2′B, P3′B will appear darker at the end of the second personalisation. On the other hand, if the equivalent matrix P4′ has fewer dots that are more reactive to the laser beam than the original matrix, then the corresponding pixel will appear lighter than the original P4A after the forged personalisation.

In that way, each pixel or matrix has a certain number of dots that are variably pre-sensitised, so that after being subjected to a laser beam, the pixels change their appearance and all the pixels that are thus subjected to the second personalisation form a predetermined motif such as lines or text or a logo etc.

The forged personalisation may have the effect of destroying a photograph. Here, the change in the appearance of the pixels can lead to a reduction in the resolution of the photograph, also called depixelisation, which consists in reducing the resolution from 300 dpi, for instance, to 50 or 100 dpi. That leads to the appearance of squares in the photograph, which considerably reduce its focus.

FIG. 4 is a very schematic illustration of the effects produced in the event of the forged personalisation of a card secured according to the invention. In this figure, the entire surface of the card has been secured. The attempt to forge the card by altering the photograph and adding a surname is immediately visible to the naked eye. For instance, the attempt to alter the face has led to the appearance of darker bands 15 and other lighter bands 15. The addition of hair has led to appearance of darker lines 16 of the guilloches type in the added hair, and lastly, in the area where the forger has tried to add a surname, the added surname 11A appears in irregular dotted lines because the pixels that make up the alphanumeric characters appear darker or lighter. Similarly, the modified FIG. 14A of the security number appear bolder and darker than the unchanged figures.

The number of pre-sensitised dots is not necessarily constant for a given shade of grey. That is particularly so if different rendering is required in the case of a forging attempt. All combinations are thus possible—different number of pre-sensitised dots for the same grey rendering, identical number of pre-sensitised dots but with different values for different rendering etc.

Some of the existing grey shades react more strongly to the laser beam than others and therefore darken faster than the others. A certain number S of the most reactive points is selected. For each of the S grey shades selected, a number M of dots to be pre-sensitised to that Sth grey shade is selected. Lastly, the S*M points to be pre-sensitised to different shades of grey are distributed in a matrix P so that the average density obtained for the matrix is equivalent to the predetermined required density of the corresponding pixel. That distribution is variable—it may be made in a totally random way or be fixed.

In the example of FIG. 3, thirteen pre-sensitised dots are distributed in the matrix P1′, eight of which have a first grey shade with a density of 10 and five others have a second grey shade with a density equal to 23. In the matrix P2′ eleven dots with the same grey shade with density of 10 are distributed. In the matrix P3′, eighteen pre-sensitised dots are distributed, eleven with a first grey shade with a density of 10 and seven others with a second grey shade with a density equal to 23. In the matrix P4°, twelve pre-sensitised dots are distributed, seven of them with a first grey shade with a density of 10, five others with a second grey shade with a density of 40.

The pre-sensitisation of the dots is achieved by a laser beam conventionally used for printing on information media. The laser used may for instance be a laser of the YAG type, among others. The laser beam scans each of the N dots of each matrix P and with each change in grey density, the power of the laser beam is adjusted, so that the dot is correctly sensitised and has the required grey density. Such pre-sensitisation of some dots is carried out advantageously at the same time as the laser printing of the areas to be printed. Thus, for the pixels to be printed where the average grey density is predetermined, the laser beam scans all the dots of the corresponding matrix so that they all have a certain grey density, some of them being pre-sensitised to a grey shade that is sensitive to laser radiation. At the end of the printing step, each dot of the matrix has a grey density such that the average density of the N dots is equivalent to the predetermined density of the corresponding pixel to be printed.

If the anti-forgery means are placed on the entire surface of the information medium, all the N dots of each matrix corresponding with each pixel of the surface are scanned by the laser beam. When the dots are not to be pre-sensitised, and are in an area that is white in colour, the laser beam is cut off.

The dot matrix is not organised, since the pre-sensitised dots can be distributed randomly in the matrix, and a forger must scan all the N dots of the matrix and analyse them. That multiplies the forging time by the number N of dots in the matrix. Also, distributing the pre-sensitised dots randomly in each matrix means that from one matrix to the next, the pre-sensitised dots are never in the same position in the matrix, and are not necessarily in the same number M*S and do not necessarily have the same grey density S. As a result, any forger has to analyse the N dots of each matrix corresponding to one pixel before making any additions to the personalisation.

Also, care must taken while selecting the number of dots N per matrix, as the number must be the maximum, first for obtaining optimum contrast that is immediately visible to the naked eye between the different pixels after forged personalisation and second for increasing the time required to analyse each pixel in the event of a forgery accordingly. However, it must be as little as possible so that the time taken for the original personalisation is reasonable.

According to one variant, the distribution of pre-sensitised dots may be determined so as to contain encoded information about the medium or the personalisation. In that case, the positioning of the pre-sensitised dots is selected carefully to make it possible to reveal the information encoded when the personalisation is forged. Thus, for example, on a matrix of nine dots corresponding to the original pixel, two pre-sensitised dots are placed in the matrix so that the combination of the matrix with an adjacent matrix, i.e. two pre-sensitised dots, shows an alphanumeric character, for instance, if any additions are made. The code may be repeated in a photograph, for example. In that case, the information may be retrieved by precisely scanning the dark and light parts of the picture on which these sets of points can be made visible. In this case, the pre-sensitised dots have a dual function—they react differently to any further laser printing and also make it possible to encode information.

The anti-forgery means cannot be detected by a simple visual examination of the personalised medium. Afterwards, if a fraudulent attempt is made to laser print on or around the existing personalisation, the appearance of the pixels will be modified as they will appear lighter or darker, and show a predetermined motif on the added printing. That change in appearance occurs insofar as the extra energy received on each pixel exceeds an energy limit required to make the pixel dots react, so that the change in the average overall density of each pixel is visible to the naked eye.

The example that has been described is only an illustrative example, and the invention is not limited to that mode of embodiment. Means other than a laser beam may also be used for pre-sensitising and for forging the personalisation, within the scope of the invention. For example, the application of a drop of ink sensitive to laser beams and applied by the inkjet process or thermal sublimation on the points to be pre-sensitised may be envisaged as well.

Alternatively, the dots, printed by inkjet or thermal sublimation (D2T2) for instance, could be pre-sensitised by adding a drop of varnish that can variably repel an ink drop applied subsequently during fraudulent printing with inkjet or thermal sublimation, so that the pixel corresponding with the dot matrix appears lighter or darker than the surrounding pixels. In this case, the concentration of ink-repelling agent in the varnish applied is varied so that the varnish repels the ink drop to a variable degree.

1. An information medium comprising:
personalisation information placed on at least one main surface of the information medium; and
invisible anti-forgery means placed on at least part of the at least one main surface and designed to undergo a change in appearance in the event of any attempt to add to the personalisation, wherein the anti-forgery means are formed by a subdivision of each pixel into a matrix of N dots, the said N dots having each a different colour density so as to enable the achievement of an average colour density of the said matrix equivalent to a colour density predetermined for the corresponding pixel, at least some (S*M) of the said N dots of the matrix being pre-sensitised to induce a colour darkening more or less quicker as compared to other non pre-sensitised dots, in the event of additional personalisation.

2. The information medium according to claim 1, wherein the anti-forgery means are placed on the whole of the said surface.

3. The information medium according to claim 1, wherein the anti-forgery means are placed on the printed areas comprising the said personalisation information.

4. The information medium according to any of claims 1 to 3, wherein each matrix includes a distribution of a predetermined number (M) of pre-sensitised dots per predetermined shade (S) of colour reactive to additional personalisation.

5. The information medium according to claim 4, wherein the distribution of the pre-sensitised dots is random.

6. The information medium according to claim 4, wherein the distribution of the pre-sensitised dots is selected so as to contain coded information relating to the medium or the personalisation.

7. The information medium according to any of claims 1 through 3, comprise wherein at least one matrix comprises more pre-sensitised dots than at least one other matrix, so that in the event of additional personalisation, some pixels appear darker and others lighter than the non pre-sensitised pixels.

8. A medium for securing an information medium having personalisation information placed on at least one main surface of the information medium, and invisible anti-forgery means placed on at least part of the at least one main surface and designed to undergo a change in appearance in the event of any attempt to add to the personalisation, the process of making of the anti-forgery means comprising the following steps:
subdivision of each pixel into a matrix of N points,
pre-sensitisation of at least some of the said N dots to a predetermined colour density so that the average density of the matrix is equivalent to the density predetermined for the corresponding pixel,
the said pre-sensitised dots being designed to darken more or less quicker than dots that are not pre-sensitised, in the event of any additional personalisation so as to modify the visual appearance of the pixel corresponding to the matrix.

9. The medium for securing an information medium according to claim 8, wherein the pre-sensitisation is carried out on the printed areas with the said personalisation information, simultaneously with the printing step.

10. The medium for securing an information medium according to claim 8, wherein the pre-sensitisation is carried out on the entire surface of the medium, simultaneously with the printing of the personalisation information.

11. The medium for securing an information medium according to any of claims 8 to 10, wherein the pre-sensitisation of dots is carried out with a laser beam that scans the N dots of each matrix.

12. The medium for securing an information medium according to claim 11, wherein the energy of the laser beam is set for each dot to be printed or pre-sensitised.

13. The medium for securing an information medium according to any of claims 8 to 10, wherein the pre-sensitising of the dots of a matrix corresponding with a pixel includes the following steps;
selecting a certain number S of colour shades that are more reactive to the laser beam,
for each shade S selected, selecting a number M of dots to be pre-sensitised, —distributing the M*S dots to be pre-sensitised in the matrix so that the average colour density of the matrix is equivalent to the predetermined density of the pixel corresponding with the matrix.

14. The medium for securing an information medium according to claim 13, wherein the M*S dots to be pre-sensitised are distributed randomly in the matrix.

15. The medium for securing an information medium according to claim 13, wherein les M*S points to be pre-sensitised are distributed in a definite way so as to contain coded information about the medium or the personalisation.

16. The medium for securing an information medium according to any of claims 8 to 10, wherein the pre-sensitising of the dots is carried out by applying a drop of varnish designed to repel to a variable degree a drop of ink applied during any attempt to do additional personalisation.

17. The medium for securing an information medium according to claim 16, wherein the pre-sensitisation of the dots of a matrix corresponding with a pixel includes the following steps:
selecting a certain number S of concentrations of ink-repelling agent in the varnish,
for each concentration S selected, selecting the number M of dots to pre-sensitise,
distributing the M*S dots to pre-sensitise in the matrix so that the average colour density of the matrix is equivalent to the predetermined density of the pixel corresponding with the matrix.
